(19) United States
(12) Patent Application Publication
(10) Pub. No.: US 2015/0358593 A1
(43) Pub. Date: Dec. 10, 2015

(54) IMAGING APPARATUS AND IMAGE SENSOR

(71) Applicant: RICOH IMAGING COMPANY, LTD., Tokyo (JP)

(72) Inventor: Koichi SATO, Saitama (JP)

(73) Assignee: RICOH IMAGING COMPANY, LTD., Tokyo (JP)

(21) Appl. No.: 14/723,808

(22) Filed: May 28, 2015

(30) Foreign Application Priority Data
Jun. 4, 2014 (JP) 2014-115599

(51) Int. Cl. H04N 9/04; H04N 5/232; H04N 5/345

(52) U.S. Cl. CPC H04N 9/045; H04N 5/3452; H04N 5/23212

(57) ABSTRACT

An imaging apparatus includes an image sensor including pixel units for photoelectrically converting an object image formed through a photographic optical system, each of the pixel units including at least three photoelectric conversion elements arranged in a plane in which the object image is formed; a focus detector which performs a phase-difference focus detection operation using an image signal obtained by the photoelectric conversion elements; and an image generator which generates an image from the image signal. The at least three photoelectric conversion elements of each of the pixel units include at least three different types of spectral sensitivity characteristic elements which have mutually different in spectral sensitivity characteristics. Identical spectral sensitivity characteristic elements of the spectral sensitivity characteristic elements that are respectively provided in adjacent two of the pixel units are symmetrically arranged in one of a lateral and a longitudinal direction.

### BACKGROUND OF THE INVENTION

### Field of the Invention

The present invention relates to an imaging apparatus which performs both a phase-difference focus detection operation and an image-signal output operation using an image sensor for imaging objects.

In digital cameras capable of taking moving images and still images, a technique of achieving a phase-difference detection type of focus detection using an image sensor (image pickup device) for use in capturing images has been proposed. In a phase-difference detection method, light rays which are passed through the exit pupil of a photographing optical system are split into two rays to be respectively received by a pair of light-receiving element arrays for focus detection. Thereafter, the amount of deviation of a focal point (amount of defocus) is determined by detecting the amount of deviation between the signal waveforms of a pair of images output in accordance with the amounts of light received by the pair of light-receiving element arrays, i.e., the amount of deviation between the relative positions of the pair of images which occurs in the direction of dividing the exit pupil of the light rays (Japanese Unexamined Patent Publication Nos. 2012-059845 and 2013-54137).

In Japanese Unexamined Patent Publication Nos. 2012-059845 and 2013-54137, a Bayer color filter array (arrangement) is adopted as a color filter array (CFA) of an image sensor, and a micro lens element and four color filters (a red filter, a blue filter and two green filters) are provided for each pixel (pixel unit) in which four photoelectric conversion elements are formed. A plurality of such pixel units are arranged in a matrix so that the pixel units form a Bayer arrangement, in which green (G) color filters and red (R) color filters are alternately arranged in each odd row in the order from left to right, while blue (B) color filters and green (G) color filters are alternately arranged in each even row in the order from left to right. The four photoelectric conversion elements of each pixel unit are configured to receive object-emanating light rays which pass through different regions of the exit pupil of a photographic lens system via a common micro lens element for performing pupil division. The focus detection method detects (determines) the amount of deviation of a focal point (amount of defocus) of the object image by, e.g., in the case of detecting a focus on a pattern of vertical stripes as an object image, adding signals from the photoelectric conversion elements in the vertical direction having the same color filters out of the four photoelectric conversion sections of each pixel unit, and detecting the amount of lateral deviation (image spacing) between a first image signal generated from the sum of the signals output from one of two light-receiving element arrays (e.g., the left light-receiving element array) and a second image signal generated from the sum of the signals output from the other light-receiving element array (e.g., the right light-receiving element array).

In Japanese unexamined patent publication No. 2006-032913, a method of reducing color moire has been proposed using an image sensor which incorporates a micro lens element on each repeating unit of a Bayer color filter array without the use of an optical low-pass filter in an image sensor having a Bayer color filter array.

However, since the imaging apparatuses disclosed in the above-mentioned Japanese Unexamined Patent Publication Nos. 2012-059845 and 2013-54137 are each provided with color filters on each pixel unit, an optical low-pass filter is required to reduce color moire. On the other hand, the imaging apparatus disclosed in the above-mentioned Japanese unexamined patent publication No. 2006-032913 cannot perform a phase-difference focus detection operation using image signals output from the image sensor.

The present invention has been accomplished in view of the above described problems, and an object of the present invention is to provide an imaging apparatus which outputs both an image signal for use in imaging and an image signal for use in phase-difference detection (phase detection) using an image sensor for imaging objects and which can reduce color moire. Another object of the present invention is to provide such an image sensor.

### SUMMARY OF THE INVENTION

According to an aspect of the present invention, an imaging apparatus is provided, including an image sensor which includes a plurality of pixel units for photoelectrically converting an object image formed through a photographic optical system, which is provided on the imaging apparatus, each of the pixel units including at least three photoelectric conversion elements arranged in a plane in which the object image is formed; a focus detector which performs a phase-difference focus detection operation using an image signal obtained by the photoelectric conversion elements; and an image generator which generates an image from the image signal. The at least three photoelectric conversion elements of each of the pixel units include at least three different types of spectral sensitivity characteristic elements which have mutually different in spectral sensitivity characteristics. Identical spectral sensitivity characteristic elements of the spectral sensitivity characteristic elements that are respectively provided in adjacent two of the pixel units are symmetrically arranged in one of a lateral and a longitudinal direction.

It is desirable for the identical spectral sensitivity characteristic elements that are respectively provided in the adjacent two of the pixel units to be arranged at line-symmetrical positions with respect to an imaginary center line that is defined between the adjacent two pixel units, which are one of laterally and longitudinally adjacent to each other, on a plane orthogonal to an optical axis of the photographic optical system.

It is desirable for at least one pair of identical spectral sensitivity characteristic elements, for use in the phase-difference focus detection operation, of the spectral sensitivity characteristic elements which are respectively positioned in two obliquely adjacent pixel units of the pixel units to be arranged at line-symmetrical positions with respect to an imaginary center line that is defined between the two obliquely adjacent pixel units of the pixel units on a plane orthogonal to an optical axis of the photographic optical system.

It is desirable for each of the plurality of pixel units to include a single micro lens which is positioned in front of the photoelectric conversion elements of each associated the pixel units.

It is desirable for each of the photoelectric conversion elements to include a photodiode, and for different spectral sensitivity characteristics to be exhibited by color filters having different colors which are fixed onto the photodiodes.

It is desirable for each of the photoelectric conversion elements to include a photodiode, and for different spectral sensitivity characteristics to be exhibited by appropriately setting a thickness of a surface p+ layer of the photodiode.

In an embodiment, an image sensor is provided, including a plurality of pixel units for photoelectrically-converting an object image formed through a photographic optical system, each of the pixel units including at least three photoelectric conversion elements arranged in a plane in which the object image is formed. The at least three photoelectric conversion elements included in each of the pixel units respectively include at least three different types of spectral sensitivity characteristic elements which are mutually different in spectral sensitivity characteristics. The spectral sensitivity characteristic elements, which have mutually different in spectral sensitivity characteristics, are arranged to maintain symmetry between any two of the pixel units that are adjacent to each other one of longitudinally and laterally.

According to the present invention, both an image signal for use in imaging and an image signal for use in phase-difference detection can be obtained even if pixels for use in imaging and pixels for use in phase-difference detection are not provided independently. Moreover, according to an aspect of the present invention, color moire can be reduced with no need to perform any complicated imaging process because at least three different types of spectral sensitivity characteristic elements are included in each pixel unit.

The present disclosure relates to subject matter contained in Japanese Patent Application No. 2014-115599 (filed on Jun. 4, 2014) which is expressly incorporated herein by reference in its entirety.

### BRIEF DESCRIPTION OF THE DRAWINGS

The present invention will be described below in detail with reference to the accompanying drawings in which:

FIG. 1 is a block diagram showing main components of an embodiment of a digital camera, to which an imaging apparatus according to the present invention has been applied;

FIG. 2 is a diagram illustrating a first embodiment of the arrangement pattern of color filters, which exhibit spectral sensitivity characteristics, of a so-called back irradiation type image sensor provided in the imaging apparatus;

FIG. 3 is a sectional view of a portion of the back irradiation type image sensor shown in FIG. 2, taken along the line shown in FIG. 2;

FIG. 4 is a diagram illustrating the arrangement of the photodiodes contained in the image sensor;

FIG. 5 is a diagram illustrating a second embodiment of the arrangement pattern of the color filters, which exhibit different spectral sensitivity characteristics;

FIG. 6 is a diagram illustrating a third embodiment of the arrangement pattern of the color filters, which exhibit different spectral sensitivity characteristics;

FIG. 7 is a diagram illustrating a fourth embodiment of the arrangement pattern of the color filters, which exhibit different spectral sensitivity characteristics;

FIG. 8 is a sectional view of the image sensor, taken along the line VIII-VIII shown in FIG. 6;

FIG. 9 is a sectional view of the image sensor, taken along the line IX-IX shown in FIG. 6;

FIG. 10 is a sectional view of the image sensor, illustrating that the sensitivity characteristics of the image sensor vary depending on the thickness of the surface protection layer of each photodiode;

FIGS. 11A is a graph showing the relationship between the wavelength of the incident light on each photodiode, the absorption coefficient of the incident light and the absorption depth;

FIGS. 11B is a graph showing the spectral sensitivity characteristics of the image sensor shown in FIGS. 8 through 10;

FIG. 12 is a sectional view of an image sensor, different in structure from the image sensor shown in FIG. 3, to which the spectral sensitivity characteristics given to the image sensor shown in FIG. 2 are given;

FIG. 13 is a sectional view of an image sensor, different in structure from the image sensor shown in FIG. 8, to which the spectral sensitivity characteristics given to the image sensor shown in FIG. 6 are given; and

FIG. 14 is a sectional view of an image sensor, different in structure from the image sensor shown in FIG. 9, to which the spectral sensitivity characteristics given to the image sensor shown in FIG. 6 are given.

### DESCRIPTION OF THE PREFERRED EMBODIMENTS

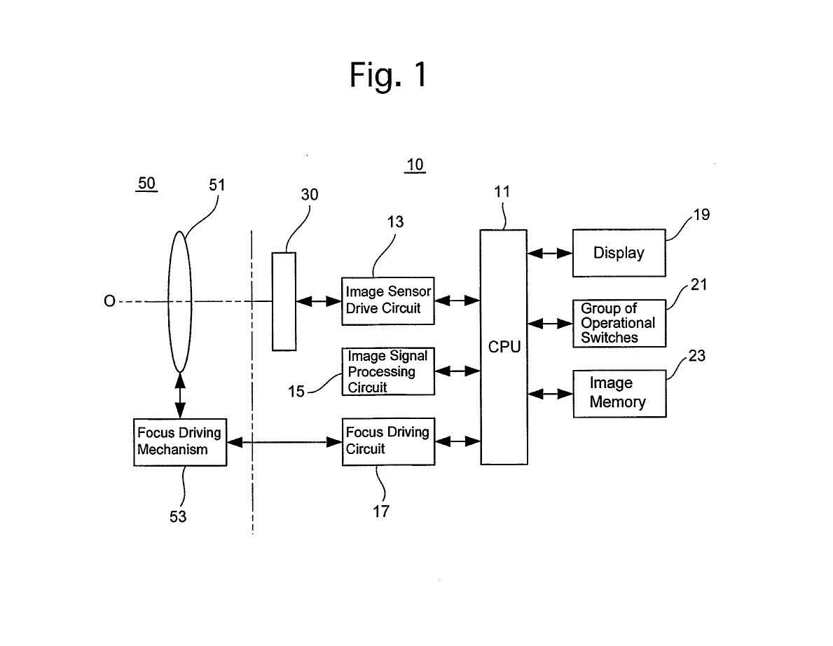

FIG. 1 is a block diagram showing the main components of an embodiment of an interchangeable-lens digital camera according to the present invention. This interchangeable-lens digital camera is provided with a camera body (imaging apparatus) 10 and an AF-compatible photographic lens system (photographic optical system/interchangeable lens system) 50 that is detachable from the camera body 10. The camera body 10 incorporates an image sensor 30 which is configured to serve not only as an image sensor for imaging objects but also as an AF module (autofocus unit) for focus detection.

The photographic lens system 50 is provided with a focusing lens group 51, and light rays emanating from an object pass through the focusing lens group 51 of the photographic lens system 50 to form an object image on a light receiving surface of the image sensor 30, which is provided in the camera body 10. The image sensor 30 is a two-dimensional color image sensor which receives incident light rays, after being separated into different color components, and converts these color components, color component by color component, into an electrical signal and outputs an image signal. The photographic lens system 50 is further provided, in addition to the focusing lens group 51, with lens groups (not shown) such as those for zooming which constitute components of a photographing optical system, and a mechanical stop (not shown).

The camera body 10 is provided therein with a CPU (focus detector) 11 which controls the overall capabilities of the camera. The CPU 11 incorporates an arithmetic unit, a ROM(s), a RAM(s), an A/D converter and a D/A converter, etc. The CPU 11 also functions as a focus detector, a focus detection method changer and an image generator. Furthermore, the CPU 11 performs a series of operations, e.g., a phase-difference focus detection operation, a focusing operation, a photographing operation, an image signal processing operation and an image signal recording operation, etc., by driving and controlling various circuits provided in the camera body 10 and the photographic lens system 50 in accordance with predetermined programs written in the ROM.

The camera body 10 is further provided therein with an image sensor drive circuit 13, an image signal processing circuit 15 and a focus driving circuit 17. The image sensor drive circuit 13 controls the imaging operation of the image sensor 30, converts an analog image signal that the image sensor 30 obtains into a digital signal and sends this digital signal to the CPU 11.

The camera body 10 is further provided with a display 19, a group of operational switches 21 and an image memory 23. The image signal processing circuit 15, the focus driving circuit 17, the display 19, the group of operational switches 21 and the image memory 23 are connected to the CPU 11. The image signal processing circuit 15 performs various image processing operations on an image obtained by the image sensor 30 such as a gamma correction operation, a color interpolation operation and an image compression operation.

The focus driving circuit 17 drives and controls the focus driving mechanism 53 of the photographic lens system 50 based on the results of focus detection calculated by the CPU 11 to drive the focusing lens group 51 in an optical axis direction to perform a focusing operation.

The display 19 is provided with an image display panel such as an LCD panel and operates to indicate information on various photographing modes of the camera, a live-view image, a review image and a focus confirmation mark (indicated upon detection of an in-focus state), etc. The group of operational switches 21 includes a power switch, a photographing commencement switch, a zoom switch, a mode selection switch and other switches. The photographing commencement switch includes a photometering switch for use in starting a live-view mode, a photometering operation and a focus detection operation, and a release switch for writing (storing) the signal of a photographed image into the image memory 23. The image memory 23 is a removable flash memory for storing photographed image signals (image data).

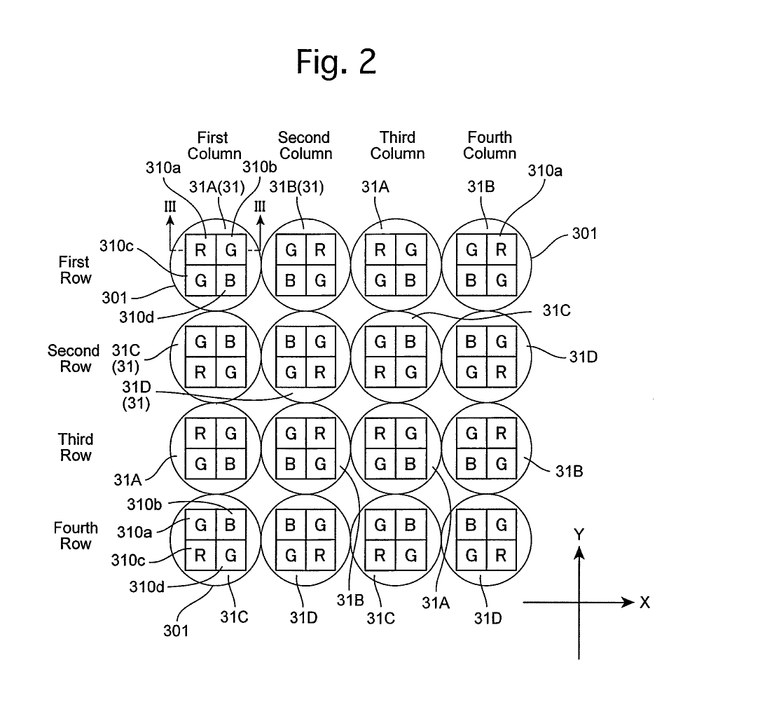

FIG. 2 is a diagram illustrating a first embodiment of the arrangement pattern of color filters (spectral sensitivity characteristic elements), which exhibit spectral sensitivity characteristics, of the image sensor 30 shown in FIG. 1 to the image sensor 30. The image sensor 30 is a so-called two-dimensional CMOS area sensor. FIG. 2 shows the image sensor 30 as viewed from the photographing optical system side (from the front of the image sensor 30). In the descriptions of the present specification, the direction normal to the light receiving surface of the image sensor 30 is defined as the Z-axis direction, the lateral (horizontal) direction of the pixel arrangement on the light receiving surface of the image sensor 30 is defined as the X-axis direction and the longitudinal (vertical) direction of the same pixel arrangement is defined as the Y-axis direction.

The X-axis, the Y-axis and the Z-axis define an orthogonal coordinate system in which axes thereof are mutually orthogonal to one another. The Z-axis is parallel to the optical axis of the photographic lens system 50 (which includes a focusing lens element or group) when the image sensor 30 is properly mounted to the imaging apparatus (the camera body 10), and the X-axis and the Y-axis lie in a plane parallel to a plane in which an object image is formed through the photographic lens system 50 (the focusing lens group 51). In the following descriptions, the lateral direction (leftward/rightward direction), the longitudinal direction (upward/downward direction) and the forward/rearward direction (thickness direction) correspond to the X-axis direction, the Y-axis direction and the Z-axis direction, respectively.

The image sensor 30 is configured of an array of pixel units 31 (31A, 31B, 31C and 31D) that are arranged in a matrix at regular intervals in the lateral and longitudinal directions. Each pixel unit 31 is provided with a circular micro lens (on-chip micro lens/micro lens element) 301 and a total of four color filters R, G, B and G of three different colors (R(red), G(green) and B(blue)): a red filter, a blue filter and two green filters. The micro lens 301 is fixed to the frontmost surface of the pixel unit 31, and the four color filters R, G, B and G have the same square shape as viewed from front and are shaped into equally-divided four squares made by equally dividing an inscribed square within the circular outline (contour) of the micro lens 301.

The pixel units 31 are classified into four types: pixel units 31A, 31B, 31C and 31D which are mutually different in arrangement (placement) of the four color filters R, G, B and G. Each pixel unit 31A is provided at the left pixel 310a and at the left pixel 310c, aligned in the longitudinal direction (the vertical direction with respect to FIG. 2), with one color filter R and one color filter G, respectively, and is provided at the right pixel 310b and the right pixel 310d, aligned in the longitudinal direction, with one color filter G and one color filter B, respectively, as viewed from the front (the object side). Each pixel unit 31B is provided at the left pixel 310a and the left pixel 310c, aligned in the longitudinal direction, with one color filter G and one color filter B, respectively, and is provided at the right pixel 310b and at the right pixel 310d, aligned in the longitudinal direction, with one color filter Rand one color filter G, respectively, as viewed from the front. Each pixel unit 31C is provided at the left pixel 310a and at the left pixel 310c, aligned in the longitudinal direction, with one color filter G and one color filter R, respectively, and is provided at the right pixel 310b and at the right pixel 310d, aligned in the longitudinal direction, with one color filter B and one color filter G, respectively, as viewed from the front. Each pixel unit 31D is provided at the left pixel 310a and at the left pixel 310c, aligned in the longitudinal direction, with one color filter B and one color filter G, respectively, and is provided at the right pixel 310b and at the right pixel 310d, aligned in the longitudinal direction, with one color filter G and one color filter R, respectively, as viewed from the front.

In the image sensor 30, the pixel units 31A and the pixel units 31B are alternately arranged in each odd row, and the pixel units 31C and the pixel units 31D are alternately arranged in each even row. Due to the above described arrangement of the pixel units 31A, 31B, 31C and 31D, pairs of color filters R and G and pairs of color filters G and R are alternately arranged at the upper lateral halves of the pixel units 31A and 31B in each odd row, in that order from the left side; pairs of color filters G and B and pairs of color filters B and G are alternately arranged at the lower lateral halves of the pixel units 31A and 31B in each odd row, in that order from the left side; pairs of color filters G and B and pairs of color filters B and G are alternately arranged at the upper lateral halves of the pixel units 31C and 31D in each even row, in that order from the left side; and pairs of color filters R and G and pairs of color filters G and R are alternately arranged at the lower lateral halves of the pixel units 31C and 31D in each even row, in that order from the left side.

On the other hand, in the image sensor 30, the pixel units 31A and the pixel units 31C are alternately arranged in each odd column and the pixel units 31B and the pixel units 31D are alternately arranged in each even column. Furthermore, pairs of color filters R and G and pairs of color filters G and R are alternately arranged at the left longitudinal halves of the pixel units 31A and 31C in each odd column, in that order from the upper side; and pairs of color filters G and B and pairs of color filters B and G are alternately arranged at the right longitudinal halves of the pixel units 31A and 31C in each odd column, in that order from the upper side. Additionally, pairs of color filters G and B and pairs of color filters B and G are alternately arranged at the left longitudinal halves of the pixel units 31B and 31D in each even column, in that order from the upper side; and pairs of color filters R and G and pairs of color filters G and R are alternately arranged at the right longitudinal halves of the pixel units 31B and 31D in each even column, in that order from the upper side.

According to the above described configuration, with an imaginary boundary line extending in the X-axis (lateral) direction and with an imaginary boundary line extending in the Y-axis (longitudinal) direction defined between any two adjacent pixel units 31A, 31B, 31C and 31D, the arrangement of the four color filters R, G, B and G of one of the two adjacent pixel units and the arrangement of the four color filters R, G, B and G of the other pixel unit are line-symmetrical with respect to each lateral and longitudinal imaginary boundary line.

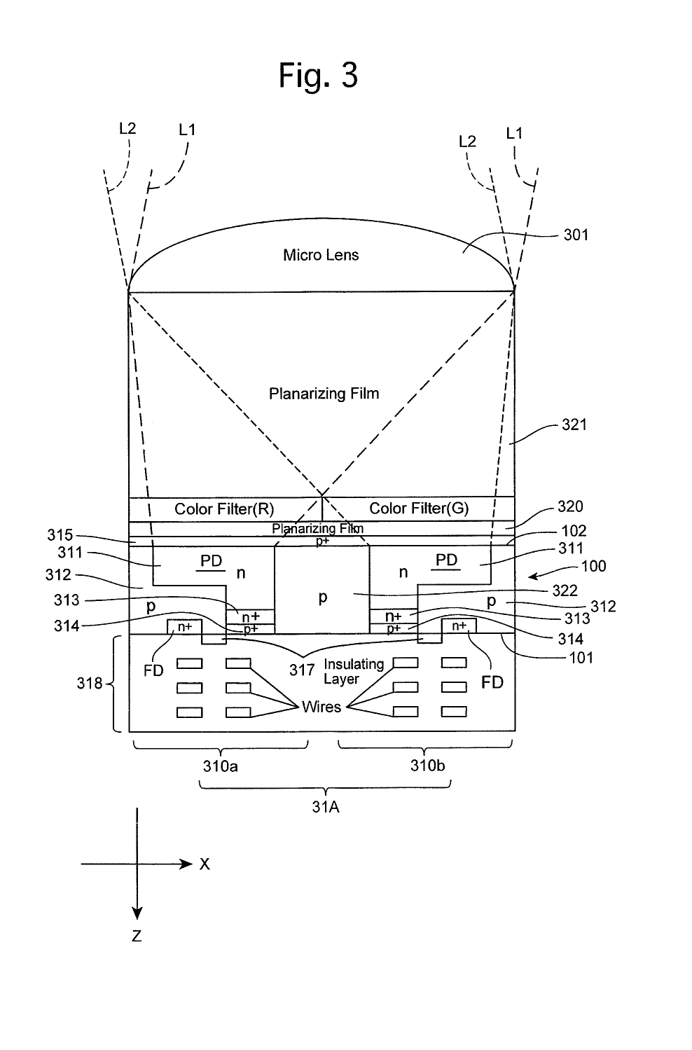

Each pixel unit 31 (31A, 31B, 31C or 31D) is provided behind the four color filters R, G, B and G thereof with four photodiodes PD, respectively (see FIG. 3) (only two of the four photodiodes PD are shown in FIG. 3). One photodiode PD is formed for each color filter R, G, B and G, so that every pixel unit 31 has a total of four photodiodes PD. The four photodiodes PD of each pixel unit 31 are spaced from one another to be line-symmetrical with respect to imaginary orthogonal lines which extend in the X-axis direction and the Y-axis direction and intersect with each other at the center of the light receiving surface of the pixel unit 31 through which the axis of the associated micro lens 301 passes. In other words, each of the four separate photodiodes PD of each pixel unit 31 is square in planar shape and smaller in size than the associated color filter R, G, B or G, the shape of a combination of the four separate photodiodes PD is also square in planar shape, and the four separate photodiodes PD of each pixel unit 31 are mutually identical in separate shape at all positions on an image plane. The four color filters R, G, B and G and the four photodiodes PD of each pixel unit 31 form four picture cells (pixels), respectively, having different spectral sensitivity characteristics. The output of each photodiode PD is used to generate a recording image (recording image signal) and is used for focus detection. The recording image can be a normal two-dimensional image such as an image defined by a format such as RAW and JPEG, etc., or can be a three-dimensional image including at least two images having parallax information. Furthermore, the recording image can either be a moving image or a still image.

FIG. 3 is a sectional view of a portion of the pixel units 31, taken along the line shown in FIG. 2. The sectional view shown in FIG. 3 shows a pixel 310a and a pixel 310b of one pixel unit 31A; the pixel 310a includes one color filter R and one photodiode PD and the pixel 310b includes one color filter G and one photodiode PD. The pixel units 31A, 31B, 31C and 31D are formed on a semiconductor substrate, specifically, an n-type semiconductor substrate 100 (silicon wafer) in the embodiment shown in FIG. 3.

The pixel units 31A, 31B, 31C and 31D, which are mutually different in configuration, are separated from one another by deep p-wells 312. In each pixel unit 31 (31A, 31B, 31C or 31D), the pixel 310a and the pixel 310b are separated from each other by a deep p-well 322. The photodiodes PD are formed on areas of the semiconductor substrate 100 in which none of the deep p-wells 312 and 322 are formed. Each photodiode PD includes an n region 311 that serves as a photoelectric conversion region and an n+ region 313 for accumulating photoelectrically-converted signal charges. Each photodiode PD is formed as a buried photodiode and further includes a p+ region 314 which is positioned between the n+region 313 and a first surface 101 of the semiconductor substrate 100 and a p+ region 315 which is positioned in front of a second surface 102 of the semiconductor substrate 100 (light receiving surface) of the n region 311. The p+ region 315 of each photodiode PD, which is positioned on the light receiving surface side, is formed entirely over each pixel region. A transfer gate 317 of each photodiode PD is a gate electrode of a transfer transistor which transfers electric charge from the n+ region 313, which is an electric charge accumulating region of the photodiode PD, to a floating diffusion FD. The transfer gate 317 is positioned on the first surface 101 via a gate insulating film (not shown). In addition, the floating diffusion FD of each photodiode PD is an n+ region.

A wiring layer 318 is provided on the first surface 101 of the semiconductor substrate 100. The wiring layer 318 includes a wiring pattern provided inside the above-mentioned gate insulating film. The micro lens 301 is positioned in front of the second surface 102 of the semiconductor substrate 100. The p+ region 315, a planarizing film (insulating layer) 320, the four color filters R, G, B and G and a planarizing film (insulating layer) 321 are provided between the micro lens 301 and the semiconductor substrate 100 and are arranged in that order from the second surface 102 side. The planarizing film 321 is a layer which defines the distance between the micro lens 301 and the second surface 102 of the semiconductor substrate 100, and the thickness of the planarizing film 321 is determined in accordance with the focal length of the micro lens 301.

The n+ region 313, which is an electric charge accumulating region of the photodiode PD, accumulates electrons (electric charge) obtained by photoelectric conversion of the incident light on the n region 311 after the n+ region 313 is fully depleted upon being reset. Therefore, in order for each photodiode PD to secure as large a light-receiving area as possible, each photodiode PD has been formed to extend as close to an adjacent photodiode PD as possible while being within a range so that the photodiode PD and the floating fusion FD maintain a sufficient space away from the adjacent photodiode PD of the adjacent pixel. In FIG. 3, the surface of each photodiode PD (the n region 311) on the incident side (i.e., the light receiving surface of each photodiode PD, which is positioned on the second surface 102 side or the micro lens 301 side) is greater in area than the surface of the photodiode PD on the first surface 101 side. With this configuration, much of the incident light on each pixel unit 31 can be received, photoelectrically converted, and accumulated by the photodiodes PD contained therein. Although two of the photodiodes PD are shown in FIG. 3, each of the pixel units 31A, 31B, 31C and 31D has a total of four photodiodes PD which correspond to the four color filters R, G, B and G.

FIG. 3 shows optical paths of a first beam of object-emanating light rays L1 and a second beam of object-emanating light rays L2 which pass through different areas of the entrance pupil of the photographic lens system 50 to be incident on one micro lens 301 among object-emanating light rays which are reflected by the same portion of an object. The first beam of object-emanating light rays L1 which pass through the micro lens 301 is incident on the photodiode PD of the left pixel 310a after passing through the color filter R, while the second beam of object-emanating light rays L2 which pass through the micro lens 301 is incident on the photodiode PD of the right pixel 310b after passing through the color filter G. The first beam of object-emanating light rays L1, specifically the red(R) component thereof, is photoelectrically converted into electric charge and accumulated by the photodiode PD of the pixel 310a, while the second beam of object-emanating light rays L2, specifically the green(G) component thereof, is photoelectrically converted into electric charge and accumulated by the photodiode PD of the pixel 310b.

Although the object-emanating light rays which pass through the color filters R and G at the upper half of the same pixel unit 31A have been illustrated above, the same can be said for the object-emanating light rays which pass through the color filters G and B at the lower half of the same pixel unit 31A and also for the object-emanating light rays which pass through the color filters R, G, B and G of any of the other three types of pixel units 31B, 31C and 31D.

All the pixel units 31 of the image sensor 30 described above are identical in structure except for the color filters R, G, B and G, and each pixel unit is used for both imaging and focus detection. Although circular in shape in the drawings, the micro lens 301 can be shaped into a square to reduce the gaps between the micro lenses 301.

A photoelectric conversion operation is performed by each pixel 310a, 310b, 310c and 310d of each pixel unit 31A, 31B, 31C and 31D, and signals output from the pixels 310a, 310b, 310c and 310d of each pixel unit 31A, 31B, 31C and 31D are used to generate a recording image signal and are used to for focus detection. For instance, the following five patterns of adding processes (1) through (5) are performed on the output signals of the pixels 310a, 310b, 310c and 310d of each pixel unit 31A, 31B, 31C and 31D:
(1) Adding the output signals of the pixels 310a, 310b, 310c and 310d
(2) Adding output signals of the pixels 310a and 310b
(3) Adding the output signals of the pixels 310c and 310d
(4) Adding the output signals of the pixels 310a and 310c
(5) Adding the output signals of the pixels 310b and 310d

Pattern (1) is used to generate a recording image signal. Patterns (2) and (3) or patterns (4) and (5) are used to generate an image signal for use in phase-difference detection. In phase-difference detection type of focus detection, a phase difference is detected from the relationship between the image signals output from two pixels on one of the two sides in the longitudinal or lateral direction in each pixel unit 31A, 31B, 31C and 31D and the image signals output from two pixels on the other side in each pixel unit 31A, 31B, 31C and 31D in the longitudinal or lateral direction. It is desirable for patterns (2) and (3) to be used to perform a phase-difference focus detection operation on an object image having a horizontal striped pattern and it is desirable for patterns (4) and (5) to be used to perform a phase-difference focus detection operation on an object image having a vertical striped pattern. The details of the phase-difference focus detection operation will be discussed later.

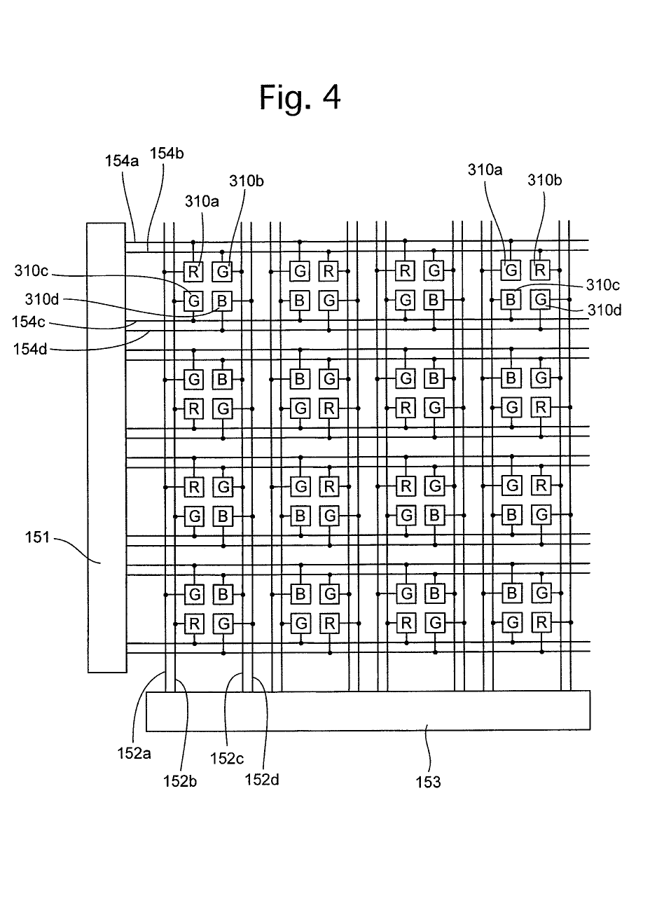

FIG. 4 is a diagram showing an example of the structure of a readout circuit provided in the image sensor 30. The image sensor 30 is provided with a vertical scanning circuit 151 and a horizontal scanning circuit 153. Horizontal signal transfer lines 152a, 152b, 152c and 152d and vertical scanning lines 154a, 154b, 154c and 154d are wired to boundary portions of the pixels 310a, 310b, 310c and 310d, respectively, so that the signals accumulated by the photodiodes PD of each pixel unit 31A, 31B, 31C and 31D are read out by the vertical scanning circuit 151 via the horizontal signal transfer lines 152a, 152b, 152c and 152d and the vertical scanning lines 154a, 154b, 154c and 154d.

In phase-difference detection suitable for a vertical striped pattern, a first image signal is generated by laterally linking the image signals which are added according to pattern (4) on the pixel units 31A and a second image signal is generated by laterally linking the image signals which are added according to pattern (5) on the pixel units 31B in the pixel units 31A and 31B that are aligned in the lateral direction. The first image signal and the second image signal are those of two line images which are formed by two beams of object-emanating light rays which are passed through different pupil areas (pupil areas spaced in the lateral direction), thus shifting laterally from each other. Accordingly, this shift amount (phase difference/ image spacing) is calculated according to a known correlation operation to detect the amount of out-of-focus (defocus amount) with respect to an object, which makes it possible to make a focus adjustment. For instance, in the case where the pixel units 31A and 31B in the first row (odd row) in FIG. 2 are used, the first image signal is a signal corresponding to a sequence of (R+G)LEFT, (R+G)LEFT, (R+G)LEFT, (R+G)LEFT, . . . , and the second image signal is a signal corresponding to a sequence of (R+G)RIGHT, (R+G)RIGHT, (R+G)RIGHT, (R+G)RIGHT, . . . ,

wherein LEFT and RIGHT correspond to the left and right pupil areas, respectively.

Accordingly, the first image signal and the second image signal become signals that are mutually identical in color component and different in pupil area, which makes detection of accurate luminance distribution possible, thus making it possible to precisely determine the amount of deviation between the two images (the amount of lateral deviation between two images/the phase difference between a pair of image signals/image spacing), so that an accurate focus adjustment can be performed. Even in the case where the pixel units 31C and 31D in even rows in FIG. 2 are used, an accurate focus adjustment can be performed in a like manner.

Although phase-difference detection suitable for a vertical striped pattern has been discussed above, patterns (2) and (3) are used in phase-difference detection suitable for a horizontal stripped pattern. For instance, in the pixel units 31A and 31C in the first column (odd column), in the case where pattern (2) is used for the pixel unit 31A and pattern (3) is used for the pixel unit 31C, the first image signal is a signal corresponding to a sequence of (R+G)TOP, (R+G)TOP, (R+G)TOP, (R+G)TOP, . . . , and the second image signal is a signal corresponding to a sequence of (R+G)BOTTOM, (R+G)BOTTOM, (R+G)BOTTOM, (R+G)BOTTOM, . . . ,

wherein TOP and BOTTOM correspond to the top and bottom pupil areas, respectively.

Accordingly, in the lateral direction also, the first image signal and the second image signal become signals which are mutually identical in color component and different in pupil area, which makes detection of accurate luminance distribution possible, thus making it possible to precisely determine the amount of deviation between the two images (the amount of lateral deviation between two images/the phase difference between a pair of image signals/image spacing), so that an accurate focus adjustment can be made. Even in the case where the pixel units 31C and 31D in even columns in FIG. 2 are used, an accurate focus adjustment can be made in a like manner since each of the first image signal and the second image signal is a sequence of signals which are mutually identical in color component.

When generating a recording image signal, pattern (1) is used on each pixel unit 31A, 31B, 31C and 31D. According to pattern (1), an image signal with RGB components is generated by using all the four pixels 310a, 310b, 310c and 310d on each pixel unit 31A, 31B, 31C and 31D, so that false color and moire can be prevented from occurring even if the image sensor 30 is no provided with any low-pass filter.

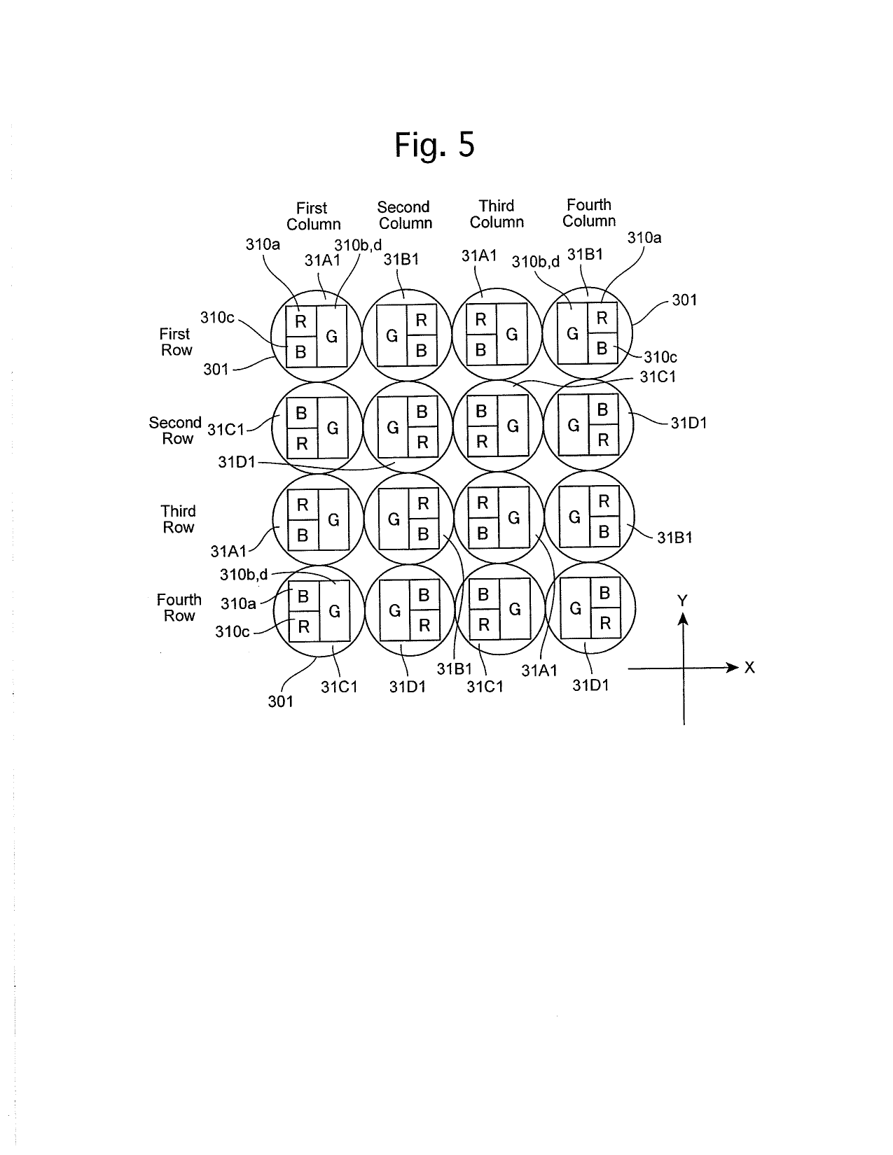

FIG. 5 is a diagram illustrating a second embodiment of the arrangement pattern of the color filters (R, G and B) of the image sensor 30 shown in FIG. 1, which is different from the arrangement pattern shown in FIG. 2. In this embodiment of the arrangement pattern, the image sensor 30 is provided with four different types of pixel units 31: pixel units 31A1, 31B1, 31C1 and 31D1, each of which has three color filters R, G and B that respectively exhibit three different types of spectral sensitivity characteristics, and the pixel units 31A1, 31B1, 31C1 and 31D1 have a mutually different arrangement of the three color filters R, G, B and G. The pixel units 31A1 and the pixel units 31B1 are alternately arranged in each odd row and the pixel units 31C1 and the pixel units 31D1 are alternately arranged in each even row. Each pixel unit 31A1 is provided, at the top left and the bottom left in the longitudinal direction, with one square color filter R and one square color filter B, respectively, and is provided at the right half of the pixel unit 31A1 with one longitudinally-elongated rectangular color filter G. Each pixel unit 31B1 is provided at the left half of the pixel unit 31B1 with one longitudinally-elongated rectangular color filter G and is provided, at the top right and the bottom right in the longitudinal direction, with one square color filter R and one square color filter B, respectively. Each pixel unit 31C1 is provided, at the top left and the bottom left in the longitudinal direction, with one square color filter B and one square color filter R, respectively, and is provided at the right half of the pixel unit 31C1 with one longitudinally-elongated rectangular color filter G. Each pixel unit 31D1 is provided at the left half of the pixel unit 31D1 with one longitudinally-elongated rectangular color filter G and provided, at the top right and the bottom right in the longitudinal direction, with one square color filter B and one square color filter R, respectively.

In the second embodiment shown in FIG. 5, the color filters R, B and G of each pixel unit 31A1, 31B1, 31C1 and 31D1 and the color filters R, B and G of any adjacent pixel unit 31A1, 31B1, 31C1 or 31D1 in the longitudinal or lateral direction are line-symmetrical with respect to an imaginary line (parallel to the X-axis or the Y-axis) which extends between two adjacent pixel units.

Similar to the image sensor 30 with the first embodiment of the arrangement pattern of the color filters, each pixel unit 31A1, 31B1, 31C1 and 31D is provided behind the three color filters R, B and G thereof with three photodiodes, respectively, though this arrangement is not shown in the drawings. The photodiode positioned behind the color filter G of each pixel unit 31A1, 31B1, 31C1 and 31D can be formed as two separate photodiodes which are arranged in a row (longitudinally) in a similar manner to the first embodiment or formed as a single-piece photodiode made of two photodiodes which are formed integral with each other.

In the second embodiment also, the first image signal and the second image signal that are used for phase-difference detection are generated as follows.

In the pixel units 31A1 and 31B1 in the first row (odd row) in FIG. 5, in the case where pattern (4) is used for the pixel unit 31A1 and pattern (5) is used for the pixel unit 31B1, the first image signal and the second image signal become similar to those in the case shown in FIG. 2; however, in the case wherein pattern (5) is used for the pixel unit 31A1 and pattern (4) is used for the pixel unit 31B1, the first image signal is a signal corresponding to a sequence of (G)RIGHT, (G)RIGHT, (G)RIGHT, (G)RIGHT, . . . , and the second image signal is a signal corresponding to a sequence of (G)LEFT, (G)LEFT, (G)LEFT, (G)LEFT, . . . .

Accordingly, each of the first image signal and the second image signal is a sequence of signals which are mutually identical in color component, which makes detection of accurate luminance distribution possible, thus making it possible to precisely determine the amount of deviation between the two images (the amount of lateral deviation between two images/the phase difference between a pair of image signals/image spacing), so that an accurate focus adjustment can be performed. Even in the case where the pixel units 31C1 and 31D1 in even rows are used, an accurate focus adjustment can be performed in a like manner. Since the color filter G has a size corresponding to the size of the sum of the color filters R and B, the luminance signal amount of the image single (G) is substantially equal to the amount of the sum of the image signal (R) and the image signal (B).

In the pixel units 31A1 and 31C1 in the first column (odd row) in FIG. 5, in the case where pattern (2) is used for the pixel unit 31A1 and pattern (3) is used for the pixel unit 31C1, the first image signal is a signal corresponding to a sequence of (R+G/2)TOP, (R+G/2)TOP, (R+G/2)TOP, (R+G/2)TOP, . . . , and the second image signal is a signal corresponding to a sequence of (R+G/2)BOTTOM, (R+G/2)BOTTOM, (R+G/2)BOTTOM, (R+G/2)BOTTOM, . . . . Accordingly, each of the first image signal and the second image signal is a sequence of signals which are mutually identical in color component, which makes detection of accurate luminance distribution possible, thus making it possible to precisely determine the amount of deviation between the two images (the amount of lateral deviation between two images/ the phase difference between a pair of image signals/ image spacing), so that an accurate focus adjustment can be performed. Even in the case where the pixel units 31B1 and 31D1 in the even columns are used, an accurate focus adjustment can be performed in a like manner. Since the color filter G has a size corresponding to the size of the sum of the color filters R and B, the luminance signal amount of the image single (G) is substantially equal to double the amount of each of the image signal (R) and the image signal (B), and accordingly, the image single (G) is multiplied by ½ (divided by 2) for level matching.

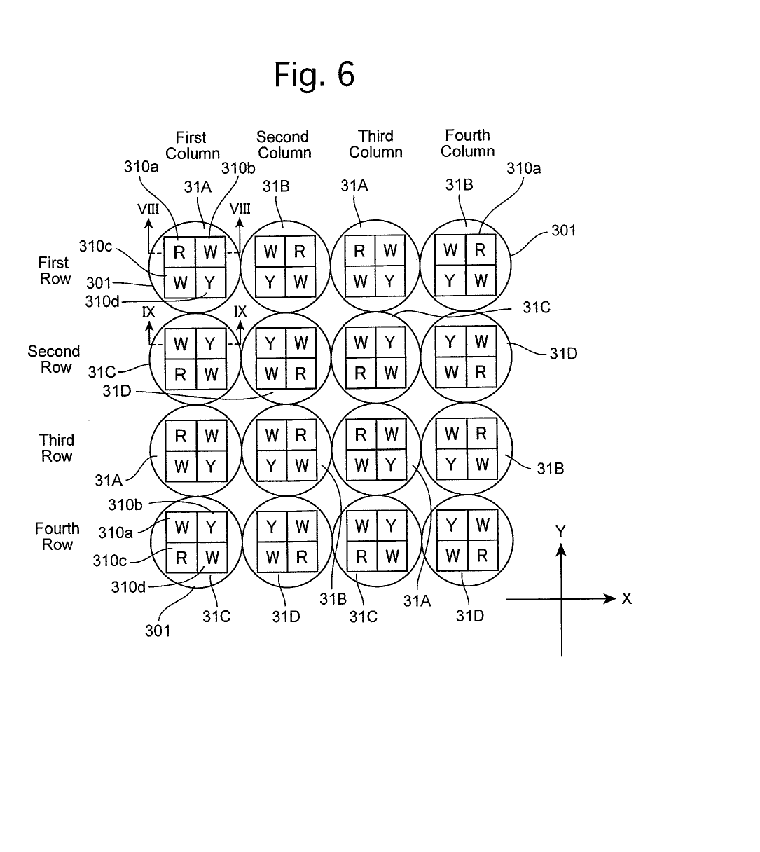

FIG. 6 shows a third embodiment of the arrangement pattern of the color filters of the image sensor 30 shown in FIG. 1, which is different from the arrangement patterns shown in FIGS. 2 and 5. This embodiment of the arrangement pattern corresponds to a modified version of the first embodiment of the arrangement pattern shown in FIG. 2, in which the color filters G and B are replaced by color filters W and Y, respectively. The arrangement of the color filters R in the third embodiment of the arrangement pattern of the color filters of the image sensor 30 is the same as the arrangement of the color filters R in the first embodiment of the arrangement pattern of the color filters of the image sensor 30. The components of the image sensor 30 other than the color filters R, Y and W thereof and the functions of these components according to the third embodiment of the arrangement pattern of the color filters of the image sensor shown in FIG. 6 are similar to those according to the first embodiment of the arrangement pattern of the color filters of the image sensor shown in FIG. 2, and accordingly, the similar components are designated by the same reference numerals and the descriptions of the similar components will be omitted from the following descriptions. Each color filter W is a white (transparent) filter and allows the color components of R(red), G(green) and B(blue) of object-emanating light to pass therethrough. Each color filter Y is a yellow filter and allows the red(R) component and the green (G) component to pass therethrough. In the third embodiment also, the color filters R, Y and W of each pixel unit 31A1, 31B1, 31C1 and 31D1 and the color filters R, Y and W of any adjacent pixel unit 31A1, 31B1, 31C1 or 31D1 in the longitudinal or lateral direction are line-symmetrical with respect to an imaginary line (parallel to the X-axis or the Y-axis) which extends between two adjacent pixel units.

The sensitivity characteristics of the color filters R, Y and W, namely, the color components which are detected by the color filters R, Y and W are as follows:

FILTER R: R

FILTER Y: R+G, and

FILTER W: R+G+B.

Due to such characteristics, the three primary color components R, G and B can be determined from the following equations:

R=R,

G=(Y−R)×α, and

B=(W−Y)×β,

wherein each of α and β denotes a level correction coefficient.

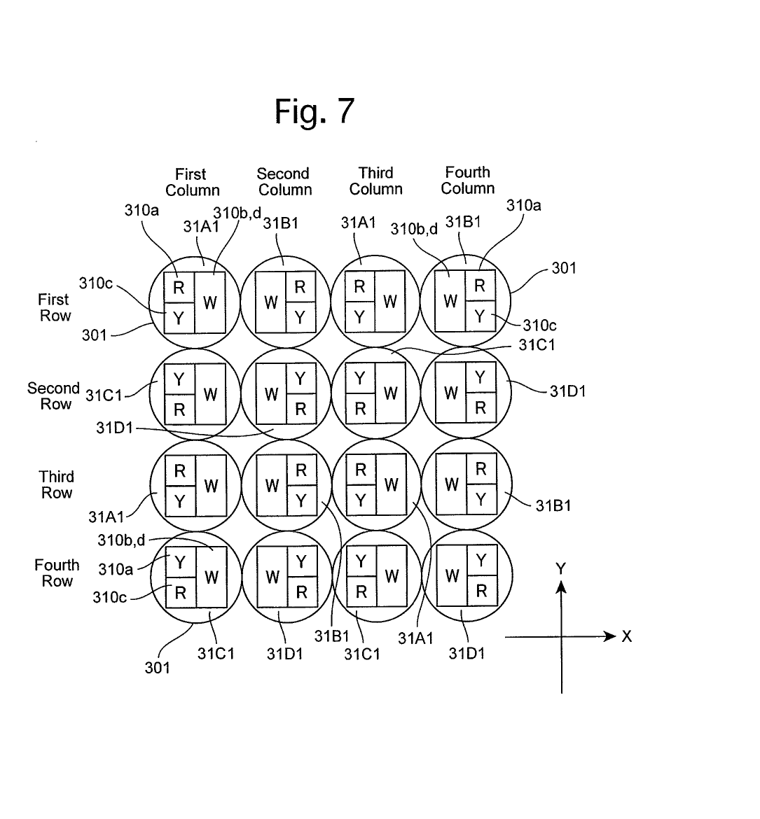

FIG. 7 shows a fourth embodiment of the arrangement pattern of the color filters of the image sensor 30 shown in FIG. 1, which is different from the arrangement patterns shown in FIGS. 2, 5 and 6. This embodiment of the arrangement pattern shown in FIG. 7 has been devised by replacing the color filters R, B and G in the second embodiment shown in FIG. 2 with color filters R, W and Y. The components of the image sensor 30 other than the color filters R, Y and W thereof and the functions of these components according to the fourth embodiment of the arrangement pattern of the color filters of the image sensor shown in FIG. 7 are similar to those according to the second embodiment of the arrangement pattern of the color filters of the image sensor shown in FIG. 2, and accordingly, similar components are designated by the same reference numerals and the descriptions of the similar components will be omitted from the following descriptions.

FIGS. 2 and 5 show different examples using the color filters R, G and B as different types of spectral sensitivity characteristic elements which exhibit different spectral sensitivity characteristics, and FIGS. 6 and 7 show different examples using the color filters R, Y and W as different types of spectral sensitivity characteristic elements which exhibit different spectral sensitivity characteristics. However, instead of using the color filters R, G and B or the color filters R, Y and W, different spectral sensitivity characteristics can be exhibited by the photodiode PD of each pixel by appropriately setting the thickness of a surface p+ layer 331 (see FIG. 10) of the n region 311.

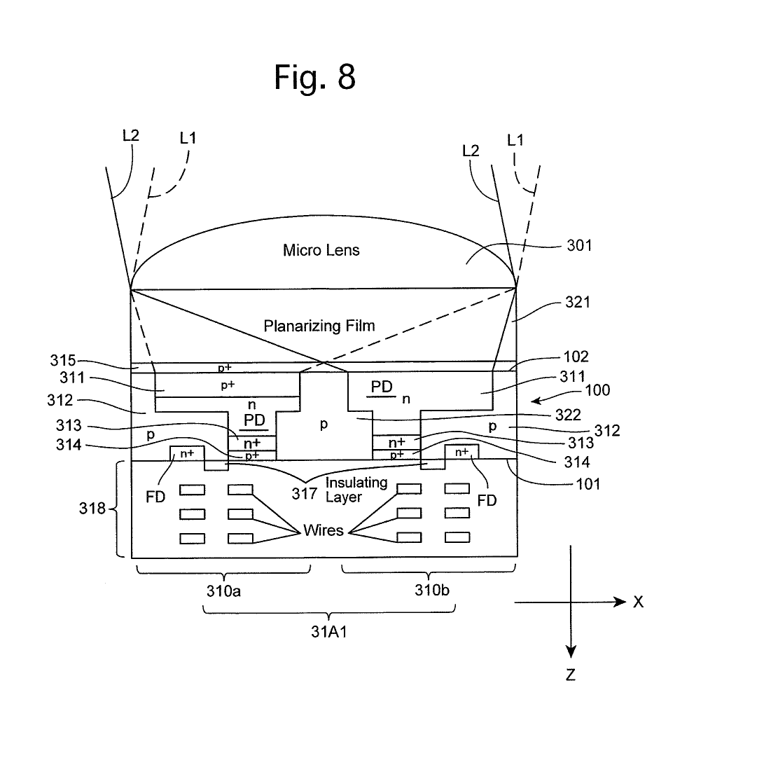

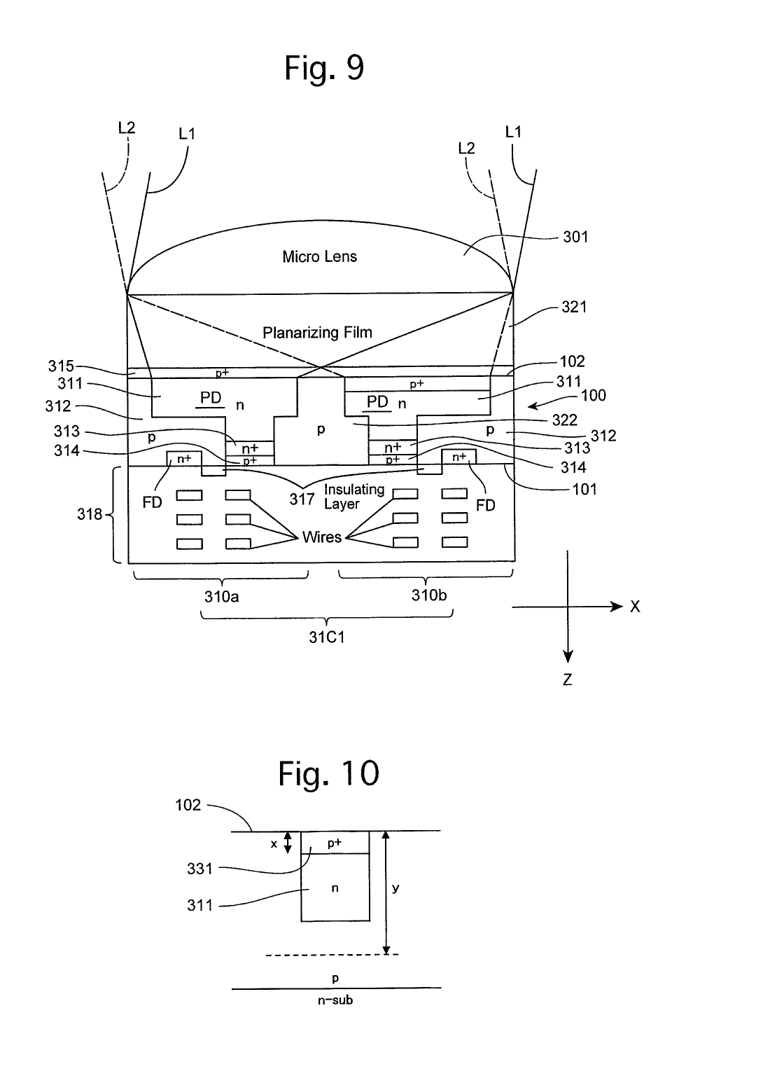

Each of FIGS. 8 and 9 is a sectional view similar to that of FIG. 3, illustrating an embodiment of the image sensor which exhibits spectral sensitivity characteristics similar to those exhibited by the color filters R, Y and W to the image sensor 30 by appropriately setting the thickness of the surface p+ layer of the photodiode PD of each pixel. The components in FIGS. 8 and 9 which are similar in function to those shown in FIG. 3 are designated by the same reference numerals, and the descriptions of the similar components will be omitted from the following descriptions.

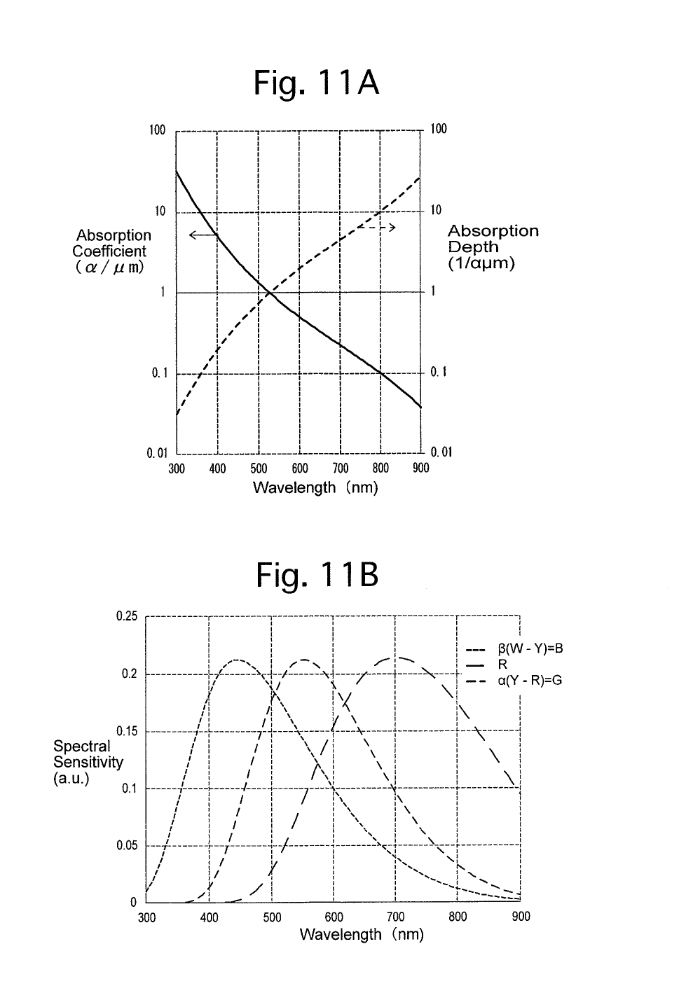

As shown in FIG. 10, if the thickness of a surface p+ layer 331 of the n region 311, i.e., the depth of the surface p+ layer 331 of the n region 311 from the second surface 102 that absorbs the incident light, is represented by x, the relationship between the wavelength of the incident light and the absorption depth is that shown in the graph in FIG. 11A, and the wavelength (i.e., color) of the incident light to be photoelectrically converted can be selected by changing the thickness x of the surface p+ layer 331. In FIG. 11A, the horizontal axis represents the wavelength (nm) of the incident light, and the vertical axis represents the absorption coefficient α(μm⁻¹) of the incident light and the absorption depth 1/α(μm).

As can be seen from FIG. 11A, the absorption coefficient a increases as the wavelength shortens and the absorption coefficient a decreases as the wavelength lengthens; in other words, the absorption depth 1/α decreases as the wavelength shortens and the absorption depth 1/α increases as the wavelength lengthens. The photodiodes PD of the image sensor shown in FIGS. 8 and 9 exhibit spectral sensitivity characteristics R, Y and W equivalent to those of the color filters R, Y and W without providing each pixel unit with any of the color filters R, Y and W. If the thickness of the surface p+ layer 331 of the n region 311 is small (or zero), light of all wavelength regions (i.e., white light) contributes to photoelectric conversion, which makes it possible for the corresponding photodiode PD to exhibit the spectral sensitivity characteristic W. If the thickness of the surface p+ layer 331 of the n region 311 is great, the blue(B) component and the green(G) component are absorbed while mainly the red(R) component contributes to photoelectric conversion, which makes it possible for the corresponding photodiode PD to exhibit the spectral sensitivity characteristic R. If the thickness of the surface p+ layer 331 of the n region 311 is a predetermined thickness between the aforementioned small thickness and great thickness, the blue(B) component is absorbed while the green(G) component and the red(R) component, i.e., the yellow(Y) component contributes to photoelectric conversion, which makes it possible for the corresponding photodiode PD to exhibit the spectral sensitivity characteristic Y.

The spectral sensitivity characteristics of each photodiode PD shown in FIGS. 8 and 9 are as shown in the graph in FIG. 11B. In FIG. 11B, the horizontal axis represents the wavelength (nm) of the incident light, and the vertical axis represents the spectrum sensitivity (a. u.). FIG. 11B shows an image signal β (the green(G) component) (which corresponds to the image signal (R+G+B) of the spectral sensitivity characteristic W from which the image signal (R+B) of the spectral sensitivity characteristic Y is subtracted), the image signal (R) (the red(R) component) of the spectral sensitivity characteristic R and an image signal a (the blue(B) component) (which corresponds to the image signal (R+B) of the spectral sensitivity characteristic Y from which the image signal (R) of the spectral sensitivity characteristic R is subtracted).

As described above, each of the image sensors shown in FIGS. 8 and 9 has spectral sensitivity characteristics and an arrangement pattern which are identical in function to those of the third embodiment shown in FIG. 6 or the fourth embodiment shown in FIG. 7, thus capable of obtaining effects similar to those obtained by the image sensor 30 shown in FIG. 3.

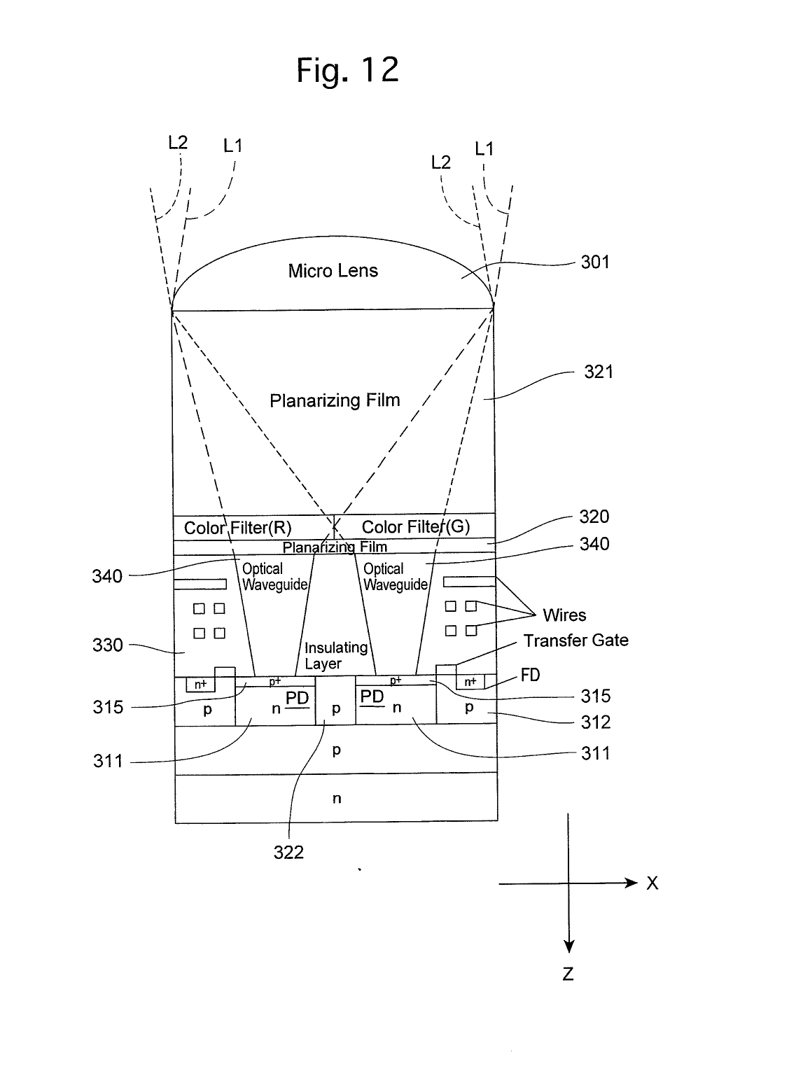

The image sensor 30 shown in FIG. 3 is a back irradiation type CMOS sensor, whereas FIG. 12 is a cross sectional view similar to that of FIG. 3, illustrating an embodiment of a front irradiation type image sensor according to the present invention. In the case where the image sensor 30 is a front irradiation type image sensor, although not shown in FIG. 12, the wiring layer 330 (318) shown in FIGS. 3, 8 and 9 is provided on the micro lens 301 side. Therefore, there is a possibility of the light which is passed through the color filters R and G being reflected diffusely or intercepted by wires of the wiring layer 330. In the embodiment shown in FIG. 12, optical waveguides 340 that guide the object-emanating light which is passed through the color filters R and G to the photodiodes PD are formed to extend from the planarizing film 320, which is positioned immediately behind the color filters R and G, to the surface p+ region 315 of each photodiode PD (the n region 311). Each optical waveguide 340 is formed such that the surface area on the color filter (R and G) side (the incident surface side) is greater than the surface area on the photodiode PD (the n region 311) side (the exit surface side). According to the embodiment shown in FIG. 12, the formation of the optical waveguides 340 makes it possible to capture much more object-emanating light which is passed through the color filters R and G into each photodiode PD (the n region 311) than the case where the image sensor is provided with no optical waveguides.

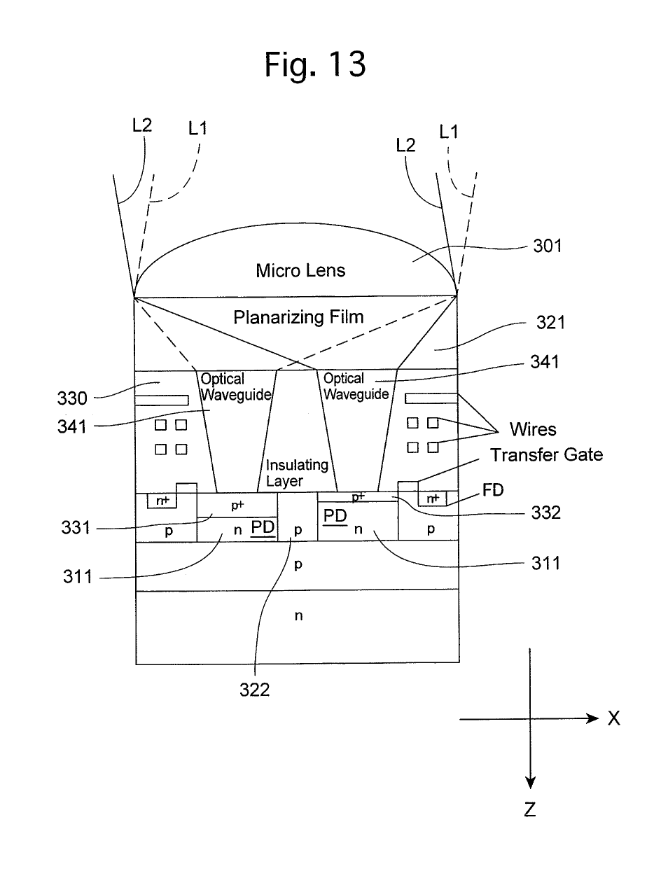

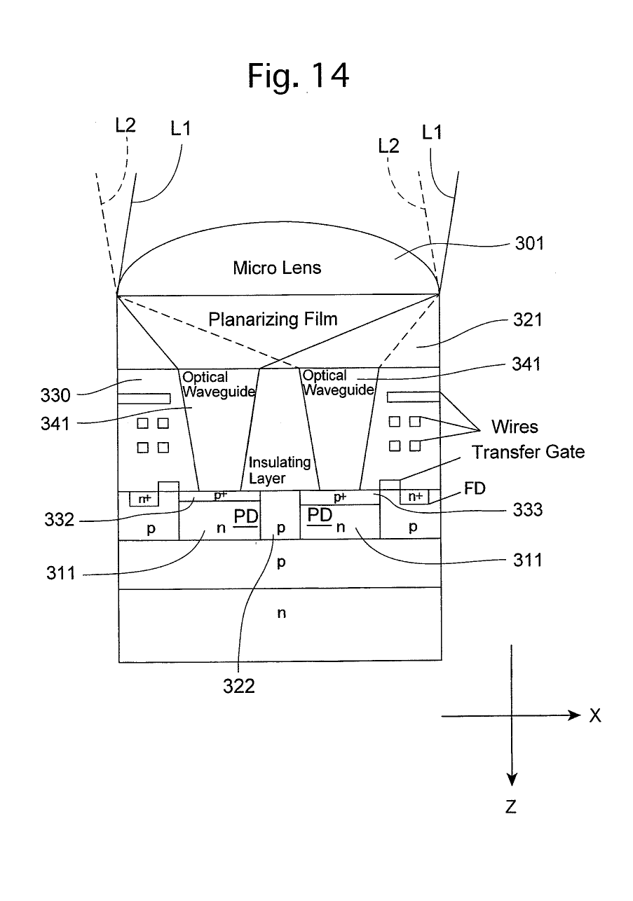

FIG. 13 shows a sectional view of a front irradiation type CMOS image sensor as a different embodiment of the image sensor 30 instead of the back irradiation type CMOS image sensor shown in FIG. 8, and FIG. 14 shows a sectional view of a front irradiation type CMOS image sensor as a different embodiment of the image sensor 30 instead of the back irradiation type CMOS image sensor shown in FIG. 9. In each of the image sensors shown in FIGS. 13 and 14, optical waveguides 341 (which correspond to the optical waveguides 340 shown in FIGS. 12) are formed to extend from the planarizing film 321 to surface p+ layers 331, 332 and 333 that are positioned at the front of the photodiodes PD (the n regions 311). Similar to the surface p+ layers of each photodiode PD of the image sensor shown in FIGS. 8 and 9, the surface p+ layers 331, 332 and 333 of each photodiode PD are each formed to have a thickness in order to exhibit the image sensor spectral sensitivity characteristics which correspond to those exhibited by the color filters R, Y and W. Each optical waveguide 341 is formed such that the surface area on the micro lens 301 side is greater than the surface area on the photodiode PD (the n region 311) side. According to each of the embodiments shown in FIGS. 13 and 14, the formation of the optical waveguides 341 makes it possible to capture much more object-emanating light which is passed through the micro lens 301 into each photodiode PD (the n region 311) than the case where the image sensor is provided with no optical waveguides.

In the first through fourth embodiments shown in FIGS. 2 and 5 through 7, spectral sensitivity characteristic elements (the color filters R, G, B and G or the color filters R, W, Y and W) of any four of the pixel units 31A, 31B, 31C and 31D (or 31A1, 31B1, 31C1 and 31D1) are line-symmetrically arranged with spectral sensitivity characteristic elements of a laterally/longitudinally adjacent image pixel of the four of the pixel units 31A, 31B, 31C and 31D (or 31A1, 31B1, 31C1 and 31D1). Additionally, in the first through fourth embodiments shown in FIGS. 2 and 5 through 7, the arrangement of the spectral sensitivity characteristic elements of any two of the pixel units 31A and 31D, or 31B and 31C which are adjacent to each other in an oblique direction at 45 degrees and the arrangement of the spectral sensitivity characteristic elements of any two of the pixel units 31A1 and 31D1, or 31B1 and 31C1 which are adjacent to each other in an oblique direction at 45 degrees are also each rotationally symmetrical with respect to an imaginary center point if the adjacent spectral sensitivity characteristic elements are rotated at 180 degrees about the imaginary center point in a plane parallel to a plane including both the X-axis and the Y-axis with the midpoint between the adjacent spectral sensitivity characteristic elements regarded as the aforementioned imaginary center point.

In the first embodiment shown in FIG. 2, the arrangement of the spectral sensitivity characteristic elements (the color filters R, G, B and G) of any two of the pixel units 31A and 31D which are adjacent to each other in an oblique direction at 45 degrees is line-symmetrical with respect to an imaginary center line that is defined between the adjacent pixel units 31A and 31D and obliquely extends rightwardly upwards at 45 degrees. Additionally, in the first embodiment shown in FIG. 2, the arrangement of the spectral sensitivity characteristic elements (the color filters R, G, B and G) of any two of the pixel units 31B and 31C which are adjacent to each other in an oblique direction at 45 degrees is line-symmetrical with respect to an imaginary center line that is defined between the adjacent pixel units 31B and 31C and obliquely extends rightwardly downwards at 45 degrees.

In the third embodiment shown in FIG. 6, the arrangement of the spectral sensitivity characteristic elements (the color filters R, W, Y and W) of any two of the pixel units 31A and 31D which are adjacent to each other in an oblique direction at 45 degrees is line-symmetrical with respect to an imaginary center line that is defined between the adjacent pixel units 31A and 31D and obliquely extends rightwardly upwards at 45 degrees. Additionally, in the third embodiment shown in FIG. 6, the arrangement of the spectral sensitivity characteristic elements (the color filters R, W, Y and W) of any two of the pixel units 31B and 31C which are adjacent to each other in an oblique direction at 45 degrees is line-symmetrical with respect to an imaginary center line that is defined between the adjacent pixel units 31B and 31C and obliquely extends rightwardly downwards at 45 degrees.

Although the above illustrated arrangements are such that any two adjacent pixel units which are adjacent to each other longitudinally, laterally or obliquely (line-symmetrically or rotational-symmetrically), at least one pair of identical spectral sensitivity characteristic elements which are respectively positioned in two obliquely adjacent pixel units (of the aforementioned pixel units) can be arranged at line-symmetrical positions with respect to an imaginary center line that is defined between the aforementioned two obliquely adjacent pixel units to lie in a plane orthogonal to an optical axis of the photographic lens system 50.

Although the output signals of the pixels of the image sensor are added longitudinally or laterally in the first and second embodiments shown in FIGS. 2 and 5, such an adding process is not necessarily required. For instance, each of the first image signal and the second image signal can be generated from the image signals output from every other pixel unit; namely:

the first image signal can be a signal corresponding to a sequence of (R)LEFT, (R)LEFT, (R)LEFT, . . . , and

the second image signal can be a signal corresponding to a sequence of (R)RIGHT, (R)RIGHT, (R)RIGHT, . . . .

Likewise, with respect to the oblique direction, focus direction in an oblique direction is possible if, e.g., the first image signal is generated as a signal corresponding to a sequence of (R)TOP LEFT, (R)TOP LEFT (R)TOP LEFT, . . . , and the second image signal is generated as a signal corresponding to a sequence of (R)BOTTOM RIGHT, (R)BOTTOM RIGHT, (R)BOTTOM RIGHT, . . . .

The present invention is not limited solely to the above illustrated embodiments as long as each pixel unit has at least three types of spectral sensitivity characteristic elements and the arrangement of these elements maintains a symmetrical arrangement between any two pixel units adjacent to each other either longitudinally or laterally. For instance, the rectangular color filters G shown in FIG. 5 and the rectangular color filters W shown in FIG. 7 can be arranged so that the rectangular color filter of each pixel unit is positioned in an upper or lower half of the pixel unit with the long sides of the rectangular color filter extending laterally. In the above illustrated embodiments, each pixel unit is provided with three or four spectral sensitivity characteristic elements of three different types; however, each pixel unit can be provided with more than four spectral sensitivity characteristic elements of three different types, four spectral sensitivity characteristic elements of four different types, or more than four spectral sensitivity characteristic elements of four different types so long as the arrangement of the different spectral sensitivity characteristic elements of each pixel unit are arranged to maintain symmetry between any two pixel units which are adjacent to each other longitudinally or laterally.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. An imaging apparatus comprising:
an image sensor which includes a plurality of pixel units for photoelectrically converting an object image formed through a photographic optical system, which is provided on said imaging apparatus, each of said pixel units including at least three photoelectric conversion elements arranged in a plane in which said object image is formed;
a focus detector which performs a phase-difference focus detection operation using an image signal obtained by said photoelectric conversion elements; and
an image generator which generates an image from said image signal,
wherein said at least three photoelectric conversion elements of each of said pixel units include at least three different types of spectral sensitivity characteristic elements which have mutually different in spectral sensitivity characteristics, and
wherein identical spectral sensitivity characteristic elements of said spectral sensitivity characteristic elements that are respectively provided in adjacent two of said pixel units are symmetrically arranged in one of a lateral and a longitudinal direction.

2. The imaging apparatus according to claim 1, wherein said identical spectral sensitivity characteristic elements that are respectively provided in said adjacent two of said pixel units are arranged at line-symmetrical positions with respect to an imaginary center line that is defined between said adjacent two pixel units, which are one of laterally and longitudinally adjacent to each other, on a plane orthogonal to an optical axis of the photographic optical system.

3. The imaging apparatus according to claim 1, wherein at least one pair of identical spectral sensitivity characteristic elements, for use in said phase-difference focus detection operation, of said spectral sensitivity characteristic elements which are respectively positioned in two obliquely adjacent pixel units of said pixel units are arranged at line-symmetrical positions with respect to an imaginary center line that is defined between said two obliquely adjacent pixel units of said pixel units on a plane orthogonal to an optical axis of the photographic optical system.

4. The imaging apparatus according to claim 1, wherein each of said plurality of pixel units comprises a single micro lens which is positioned in front of said photoelectric conversion elements of each associated said pixel units.

5. The imaging apparatus according to claim 1,
wherein each of said photoelectric conversion elements comprises a photodiode, and wherein different spectral sensitivity characteristics are exhibited by color filters having different colors which are fixed onto said photodiodes.

6. The imaging apparatus according to claim 1,
wherein each of said photoelectric conversion elements comprises a photodiode, and wherein different spectral sensitivity characteristics are exhibited by appropriately setting a thickness of a surface p+ layer of said photodiode.

7. An image sensor comprising a plurality of pixel units for photoelectrically-converting an object image formed through a photographic optical system, each of said pixel units including at least three photoelectric conversion elements arranged in a plane in which said object image is formed,
wherein said at least three photoelectric conversion elements included in each of said pixel units respectively include at least three different types of spectral sensitivity characteristic elements which are mutually different in spectral sensitivity characteristics, and
wherein said spectral sensitivity characteristic elements, which have mutually different in spectral sensitivity characteristics, are arranged to maintain symmetry between any two of said pixel units that are adjacent to each other one of longitudinally and laterally.
